(19) United States
(12) Patent Application Publication
(10) Pub. No.: US 2025/0315950 A1
(43) Pub. Date: Oct. 9, 2025

(54) METHODS, SYSTEMS, AND STORAGE MEDIA FOR GENERATING IMAGE PROCESSING MODELS

(71) Applicant: SHANGHAI UNITED IMAGING HEALTHCARE CO., LTD., Shanghai (CN)

(72) Inventors: Houjiao DAI, Shanghai (CN); Yang LYU, Shanghai (CN); Yun DONG, Shanghai (CN)

(73) Assignee: SHANGHAI UNITED IMAGING HEALTHCARE CO., LTD., Shanghai (CN)

(21) Appl. No.: 19/173,747

(22) Filed: Apr. 8, 2025

(30) Foreign Application Priority Data
Apr. 9, 2024 (CN) 202410424881.3

(51) Int. Cl. G06T 7/00

(52) U.S. Cl. CPC G06T 7/0012; G06T 2207/20081; G06T 2207/30204

(57) ABSTRACT

A method for generating image processing models is provided. The method is implemented on a computing device having at least one processor and at least one storage device. The method includes obtaining sample medical images corresponding to a plurality of tracer types; clustering the plurality of tracer types into a plurality of tracer clusters based on the sample medical images, each tracer cluster including one or more tracer types of the plurality of tracer types; for each tracer cluster, generating an image processing model corresponding to the tracer cluster by training an initial image processing model using first sample medical images of the sample medical images, the first sample medical images corresponding to the one or more tracer types in the tracer cluster.

### CROSS-REFERENCE TO RELATED APPLICATIONS

This application claims priority to Chinese Patent Application No. 202410424881.3, filed on Apr. 9, 2024, the entire contents of which are hereby incorporated by reference.

### TECHNICAL FIELD

The present disclosure relates to the field of medical imaging, and in particular, to methods, systems, and storage media for generating image processing models.

### BACKGROUND

A tracer is a detectable and trackable marker that is often injected into a subject during a medical scan (e.g., a positron emission tomography (PET) scan) to obtain relevant information (e.g., biological metabolic information) about the subject. Medical images corresponding to different tracer types are usually processed and analyzed by different image processing models. However, the diversity of tracer types makes it challenging for training samples of the image processing models to cover all known tracer types, thereby limiting the applicability of the image processing models due to the constraints of tracer types. Additionally, when processing a target medical image, it is necessary to rely on human input of tracer type information from a physician or technician to determine the corresponding image processing model, which is susceptible to degradation of the processing effect due to input error.

Therefore, the present disclosure provides systems and methods for generating image processing models, which can improve the application scope and processing accuracy of the image processing model.

### SUMMARY

According to an aspect of the present disclosure, a method for generating image processing models is provided. The method may be implemented on a computing device having at least one processor and at least one storage device. The method may include obtaining sample medical images corresponding to a plurality of tracer types; determining a plurality of tracer clusters based on the sample medical images, each tracer cluster including one or more tracer types of the plurality of tracer types; and for each tracer cluster, generating an image processing model corresponding to the tracer cluster by training an initial image processing model using first sample medical images of the sample medical images, the first sample medical images corresponding to the one or more tracer types in the tracer cluster. According to another aspect of the present disclosure, a system is provided. The system may include at least one storage medium storing a set of instructions and at least one processor configured to communicate with the at least one storage medium. When executing the set of instructions, the at least one processor may be directed to cause the system to perform operations including: obtaining sample medical images corresponding to a plurality of tracer types; determining the plurality of tracer types into a plurality of tracer clusters based on the sample medical images, each tracer cluster including one or more tracer types of the plurality of tracer types; and for each tracer cluster, generating an image processing model corresponding to the tracer cluster by training an initial image processing model using first sample medical images of the sample medical images, the first sample medical images corresponding to the one or more tracer types in the tracer cluster.

According to yet another aspect of the present disclosure, a non-transitory computer readable medium is provided. The non-transitory computer readable medium may include at least one set of instructions. When executed by at least one processor of a computer device, the at least one set of instructions may direct the at least one processor to perform operations including: obtaining sample medical images corresponding to a plurality of tracer types; determining the plurality of tracer types into a plurality of tracer clusters based on the sample medical images, each tracer cluster including one or more tracer types of the plurality of tracer types; and for each tracer cluster, generating an image processing model corresponding to the tracer cluster by training an initial image processing model using first sample medical images of the sample medical images, the first sample medical images corresponding to the one or more tracer types in the tracer cluster.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an imaging system according to some embodiments of the present disclosure;

FIG. 2 is a block diagram of an exemplary processing device according to some embodiments of the present disclosure;

FIG. 3 is a schematic diagram illustrating an exemplary computer device according to some embodiments of the present disclosure;

FIG. 4 is a flowchart illustrating a process for generating image processing models according to some embodiments of the present disclosure;

FIG. 5 is a flowchart illustrating a process of clustering a plurality of tracer types into a plurality of tracer clusters according to some embodiments of the present disclosure;

FIG. 6 is a schematic diagram illustrating a process of determining a feature vector according to some embodiments of the present disclosure;

FIG. 7 is a schematic diagram illustrating a training process of a first feature extraction model according to some embodiments of the present disclosure;

FIG. 8 is a schematic diagram illustrating a process of determining a feature vector according to some embodiments of the present disclosure;

FIG. 9 is a schematic diagram illustrating a training process of a second feature extraction model according to some embodiments of the present disclosure;

FIG. 10 is a schematic diagram illustrating a process of clustering tracer types according to some embodiments of the present disclosure;

FIG. 11 is a flowchart illustrating a process of processing a target medical image according to some embodiments of the present disclosure;

FIG. 12 is a schematic diagram illustrating a process of processing a target medical image according to some embodiments of the present disclosure;

FIG. 13 is a flowchart illustrating a process of determining a target tracer type of a target medical image according to some embodiments of the present disclosure;

FIG. 14 is a schematic diagram illustrating a process of determining a first probability according to some embodiments of the present disclosure;

FIG. 15 is a schematic diagram illustrating another process of determining a first probability according to some embodiments of the present disclosure;

FIG. 16 is a schematic diagram illustrating a training process of a second discrimination model according to some embodiments of the present disclosure;

FIG. 17 is a schematic diagram illustrating a process of determining a second

probability according to some embodiments of the present disclosure; and

FIG. 18 is a flowchart illustrating a process of determining whether planned tracer types need to be adjusted according to some embodiments of the present disclosure.

### DETAILED DESCRIPTION

In order to illustrate the technical solutions related to the embodiments of the present disclosure, a brief introduction of the drawings referred to in the description of the embodiments is provided below. Obviously, the drawings described below are only some examples or embodiments of the present disclosure. Those skilled in the art, without further creative efforts, may apply the present disclosure to other similar scenarios according to these drawings. Unless apparent from the locale or otherwise stated, like reference numerals represent similar structures or operations throughout the several views of the drawings.

It should be understood that the terms “system,” “device,” “unit,” and/or “module” used herein are one method to distinguish different components, elements, parts, sections, or assemblies of different levels in ascending order. However, the terms may be displaced by another expression if they achieve the same purpose.

As used in the disclosure and the appended claims, the singular forms “a,” “an,” and/or “the” may include plural forms unless the context clearly indicates otherwise. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may further include other steps or elements.

Unless otherwise defined, all technical and scientific terms used herein have the same meaning as commonly understood by those skilled in the art belonging to the present disclosure. The terms used herein in the specification of the present disclosure are for the purpose of describing specific embodiments only and are not intended to limit the invention. The term “and/or” as used herein includes any and all combinations of one or more of the relevant listed items.

The flowcharts used in the present disclosure illustrate operations that systems

implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

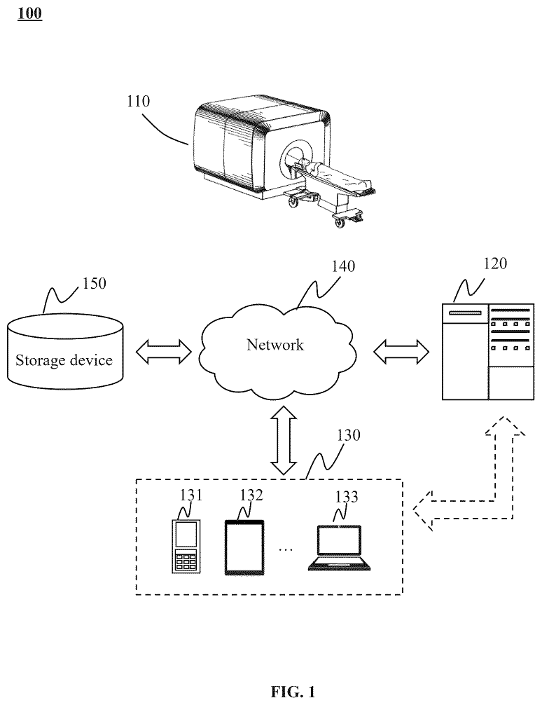

FIG. 1 is a schematic diagram illustrating an imaging system according to some embodiments of the present disclosure.

As shown in FIG. 1, an imaging system 100 may include a scanning device 110, a processing device 120, a terminal device 130, a network 140, and a storage device 150. The components of the imaging system 100 may be connected in one or more ways. Merely by way of example, as shown in FIG. 1, the scanning device 110 may be connected to the processing device 120 via the network 140. As another example, the scanning device 110 may be directly connected to the processing device 120 (as shown by the dashed bi-directional arrow connecting the scanning device 110 and the processing device 120).

The scanning device 110 may collect scan data (e.g., a medical image, projection data, PET data) of a subject. In some embodiments, the subject may include a human body, organs, a body, an injury site, a tumor, a phantom, or the like. In some embodiments, the scanning device 110 may include a positron emission tomography (PET) device, a single-photon emission computed tomography (SPECT) device, a magnetic resonance imaging (MRI) device, a multi-modality imaging device, or the like. In some embodiments, after the subject is injected with tracers of one or more tracer types, the scanning device 110 may scan the subject to obtain a medical image of the subject.

The processing device 120 may process data and/or information obtained from the scanning device 110, the terminal device 130, and/or the storage device 150. For example, the processing device 120 may obtain scan data from the scanning device 110 and generate a medical image (e.g., a sample medical image, a target medical image, a reference medical image, etc.) corresponding to the scan data based on the scan data. For example, the processing device 120 may generate an image processing model based on a plurality of sample medical images. As yet another example, the processing device 120 may process the target medical image based on the image processing model. In some embodiments, the processing device 120 may include a central processing unit (CPU), a digital signal processor (DSP), a system on a chip (SoC), a microcontroller unit (MCU), etc., and/or any combination thereof. In some embodiments, the processing device 120 may include a computer, a user console, a single server or a server group, etc. The server group may be centralized or distributed. In some embodiments, the processing device 120 may be local or remote. For example, the processing device 120 may access information and/or data stored in the scanning device 110, the terminal device 130, and/or the storage device 150 via the network 140. As another example, the processing device 120 may directly connect to the scanning device 110, the terminal device 130, and/or the storage device 150 to access the stored information and/or data. In some embodiments, the processing device 120 may be implemented on a cloud platform. Merely by way of example, a cloud platform may include a private cloud, a public cloud, a hybrid cloud, a community cloud, a distributed cloud, an inter-cloud, a multi-cloud, etc., or any combination thereof. In some embodiments, the processing device 120 or a portion of the processing device 120 may be integrated into the scanning device 110.

The terminal device 130 may display the medical image to a user and/or receive input from the user. For example, the terminal device 130 displays, to the user, a sample medical image and a target medical image before and after processing. As another example, the terminal device 130 receives user feedback entered by the user. The terminal device 130 may include a mobile device 131, a tablet computer 132, a laptop computer 133, etc., or any combination thereof. In some embodiments, the terminal device 130 may be part of the processing device 120.

The network 140 may include any suitable network that facilitates the exchange of information and/or data for the imaging system 100. In some embodiments, one or more components of the imaging system 100 (e.g., the scanning device 110, the processing device 120, the terminal device 130, the storage device 150) may communicate information and/or data with one or more other components of the imaging system 100 via the network 140. In some embodiments, the network 140 may include a wired network and/or a wireless network.

The storage device 150 may store data, instructions, and/or any other information. In some embodiments, the storage device 150 may store data obtained from the scanning device 110, the terminal device 130, and/or the processing device 120. For example, the storage device 150 may store a trained image processing model, a clustering result of a plurality of tracer types, etc. In some embodiments, the storage device 150 may include mass storage, removable memory, volatile read-write memory, read-only memory (ROM), or the like, or any combination thereof. In some embodiments, the storage device 150 may be implemented on a cloud platform. In some embodiments, the storage device 150 may be connected to the network 140 to communicate with one or more other components of the imaging system 100 (e.g., the scanning device 110, the processing device 120, the terminal device 130). One or more components of the imaging system 100 may access data or instructions stored in the storage device 150 via the network 140. In some embodiments, the storage device 150 may be directly connected to or in communication with one or more other components of the imaging system 100 (e.g., the scanning device 110, the processing device 120, the storage device 150, the terminal device 130). In some embodiments, the storage device 150 may be part of the processing device 120.

It should be noted that the foregoing description is provided for illustrative purposes only and is not intended to limit the scope of the present disclosure. For a person of ordinary skill in the art, a wide variety of variations and modifications may be made under the guidance of the contents of the present disclosure. Features, structures, methods, and other characteristics of the exemplary embodiments described herein may be combined in various ways to obtain additional and/or alternative exemplary embodiments. However, these variations and modifications do not depart from the scope of the present disclosure.

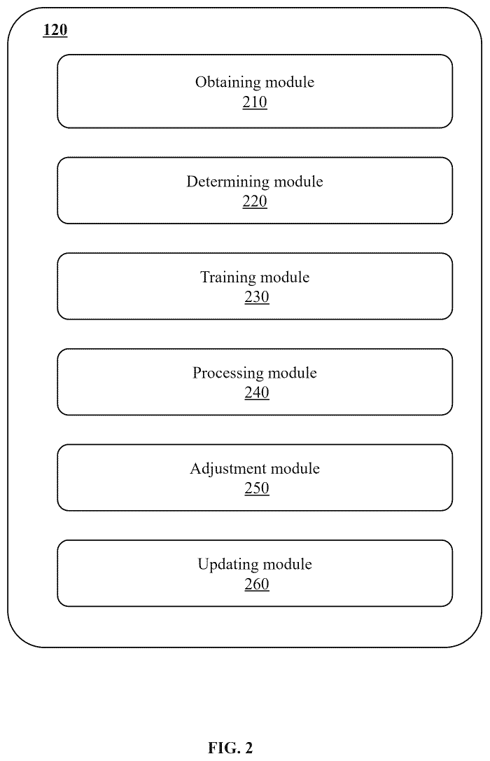

FIG. 2 is a block diagram illustrating an exemplary processing device according to some embodiments of the present disclosure. The processing device 120 may include an obtaining module 210, a determining module 220, a training module 230, a processing module 240, an adjustment module 250, and an updating module 260.

The obtaining module 210 may be configured to obtain sample medical images corresponding to a plurality of tracer types.

The clustering module 220 may be configured to cluster the plurality of tracer types into a plurality of tracer clusters based on the sample medical images.

The training module 230 may be configured to for each tracer cluster, generate an image processing model corresponding to the tracer cluster by training an initial image processing model using first sample medical images of the sample medical images.

The processing module 240 may be configured to for a target medical image corresponding to a target tracer type, determine whether the target tracer type is included in the plurality of tracer types; in response to determining that the target tracer type is included in the plurality of tracer types, determine one or more target tracer clusters that the target tracer type belongs to; and generate a processed target medical image by processing the target medical image using one or more image processing models corresponding to the one or more target tracer clusters.

The adjustment module 250 may be configured to for a target medical image corresponding to a target tracer type, determine whether the target tracer type is included in the plurality of tracer types; in response to determining that the target tracer type is not included in the plurality of tracer types, for each tracer cluster, determine a third probability that the target tracer type belongs to the tracer cluster based on the target medical image using a second discrimination model corresponding to the tracer cluster; determine one or more target tracer clusters corresponding to the target tracer type from the plurality of tracer clusters based on the third probabilities corresponding to the plurality of tracer clusters; and generate a processed target medical image by processing the target medical image using one or more image processing models corresponding to the one or more target tracer clusters.

The updating module 260 may be configured to obtain reference medical images corresponding to reference tracer types that are not included in the plurality of tracer types; for each reference tracer type, determine, based on the reference medical image corresponding to the reference tracer type, fourth probabilities that the reference tracer type belongs to the plurality of tracer clusters using second discrimination models corresponding to the plurality of tracer clusters; determine fourth position information of the reference tracer type in a feature space based on the fourth probabilities; and determine whether the plurality of tracer clusters need to be updated based on the fourth position information of each reference tracer type. It should be noted that the above description regarding the processing device 120 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the processing device 120 may include a storage module configured to store data generated by the above-mentioned modules of the processing device 120. As still another example, one or more modules may be integrated into a single module to perform the functions thereof.

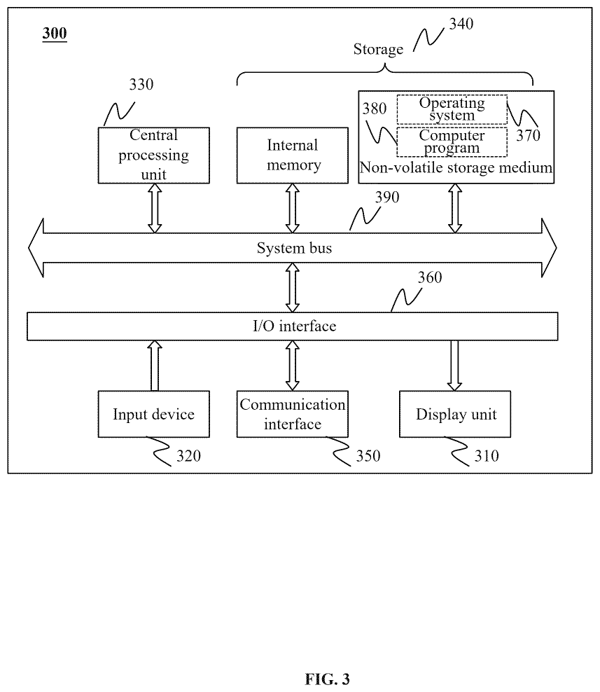

FIG. 3 is a schematic diagram illustrating an exemplary computer device according to some embodiments of the present disclosure. In some embodiments, the processing device 120 and/or the terminal device(s) 130 may be implemented on the computer device 300. As illustrated in FIG. 3, the computer device 300 may include a display unit 310, an input device 320, a graphics processing unit (GPU) (not shown in the figure), a central processing unit (CPU) 330, a storage 340, a communication interface 350, an input/output (I/O) interface 360. The display unit 310 is used to display information, which can be a display screen, a projection device. The input device 320 can be a touch layer covering the display screen, or it can be buttons, a trackball, or a touchpad set on the casing of the computer device. It can also be an external keyboard, touchpad, mouse, and so on. The GPU and the CPU 330 are used to provide computing and control capabilities. The storage 340 includes a non-volatile storage medium and an internal memory. The non-volatile storage medium stores an operating system 370 and computer programs 380. The computer programs 380 may include a browser or any other suitable image processing model generation apps for receiving and rendering information relating to an imaging system 100 from the processing device 120.

The internal memory provides an environment for the operation of the operating system and computer programs in the non-volatile storage medium. The I/O interface 360 is used for information exchange between the processor and external devices. The communication interface 350 is used to communicate with external terminals in a wired or wireless manner. Wireless communication can be achieved through Wi-Fi, mobile cellular networks, near field communication (NFC), or other technologies. When the computer program is executed by the processor, a method for obtaining an image processing network is implemented.

In some embodiments, any other suitable component, including but not limited to a system bus or a controller (not shown), may also be included in the computer device 300.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to generate a high-quality image of a subject as described herein. A computer with user interface elements may be used to implement a personal computer (PC) or another type of work station or terminal device, although a computer may also act as a server if appropriately programmed. It is believed that those skilled in the art are familiar with the structure, programming, and general operation of such computer equipment and as a result, the drawings should be self-explanatory.

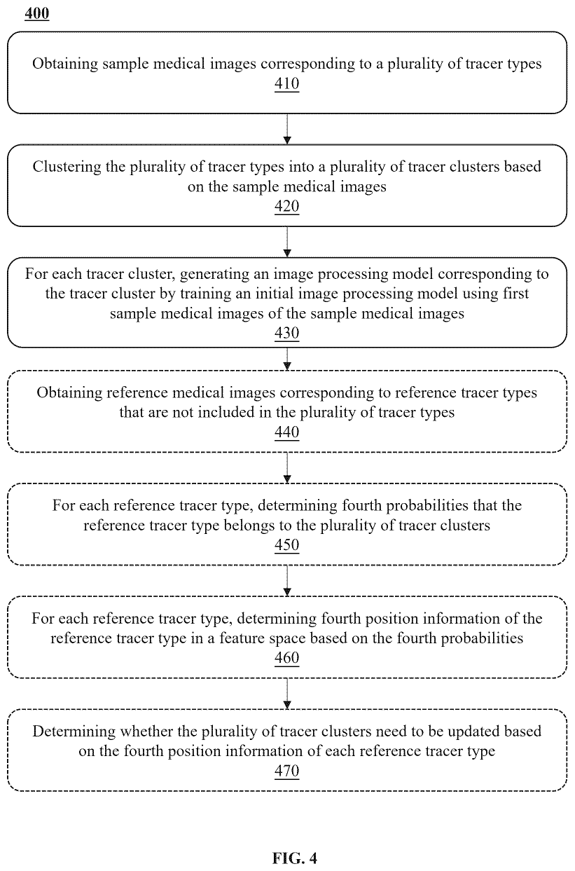

FIG. 4 is a flowchart illustrating a process for generating image processing models according to some embodiments of the present disclosure. In some embodiments, the processing device 120 may perform process 400. For example, the process 400 may be stored in a storage device (e.g., the storage device 150, a storage unit of the processing device 120) in the form of instructions, and the process 400 may be implemented when the processing device 120 executes the instructions.

In 410, sample medical images corresponding to a plurality of tracer types are obtained. In some embodiments, operation 410 may be performed by the obtaining module 210.

A tracer refers to a detectable and trackable marker that is injected into a subject during or before a medical scan (e.g., a PET scan) to obtain relevant information (e.g., biological metabolic information) about the subject. Specifically, the tracer is injected into the subject before or during the medical scan so that the tracer emits rays after reacting with a specific substance within the subject, and the scanning device detects the rays to obtain a medical image of the subject. The tracer may mark the specific substance or tissue in the medical image to provide data for supporting subsequent medical analysis. For example, in metabolic studies, PET scans may be performed after injecting Fluoro-2-Deoxy-D-Glucose (FDG) into a patient to obtain PET images of the patient, based on which the metabolism of the patient may be analyzed and studied.

With the development of medical technology, more and more tracer types are used in medical scans. Different tracer types have different properties and may provide different information. For example, the tracer types may include deoxyglucose (FDG) for tumor metabolic imaging, prostate-specific membrane antigen (PSMA) for prostate cancer diagnosis, ^{99m}Tc-labeled methylene diphosphonates for bone imaging, and ^{99m}Tc-labeled diethylenetriaminepentaacetic acid for assessing renal function.

A sample medical image refers to a historical medical image used to train the image processing models. For example, a historical medical image obtained by a scanning device after a certain tracer type is injected into a sample subject may be used as a sample medical image. After the sample medical image is obtained in a historical scan, the doctor or technician may add a tracer label, and the tracer type corresponding to the sample medical image may be determined based on the tracer label.

Different sample medical images may correspond to the same or different imaging modalities. For example, the sample medical images are all PET images. As another example, the sample medical images include PET images and MRI images. One tracer type may correspond to a plurality of sample medical images. It should be noted that the plurality of sample medical images corresponding to one tracer type may be sample medical images obtained by scanning the same tissue of different sample subjects or may be sample medical images obtained by scanning different tissues of different sample subjects. Certainly, the plurality of sample medical images corresponding to different tracer types may also include sample medical images of the same tissue of the different sample subjects and/or sample medical images of different tissues of the different sample subjects.

In some embodiments, a tracer type may only have one corresponding sample medical image. In some embodiments, a tracer type may have multiple corresponding sample medical images.

The processing device 120 may obtain the plurality of sample medical images

corresponding to the plurality of tracer types from a storage device. In some embodiments, the processing device 120 may obtain the plurality of sample medical images corresponding to the plurality of tracer types from a scanning device.

In 420, a plurality of tracer clusters are determined based on the sample medical images. In some embodiments, operation 420 may be performed by the determining module 220.

In some embodiments, the plurality of tracer types are clustered into a plurality of tracer clusters based on the sample medical images. The tracer clusters refer to tracer sets obtained by clustering tracer types. Each tracer cluster includes one or more tracer types among the plurality of tracer types. One or more tracer types in the same tracer cluster have a high similarity. For example, tracer type 1 is included in tracer cluster 1, tracer types 2 and 3 are included in tracer cluster 2, tracer types 4, 5, and 6 are included in tracer cluster 3. One tracer type may be clustered into one or more tracer clusters.

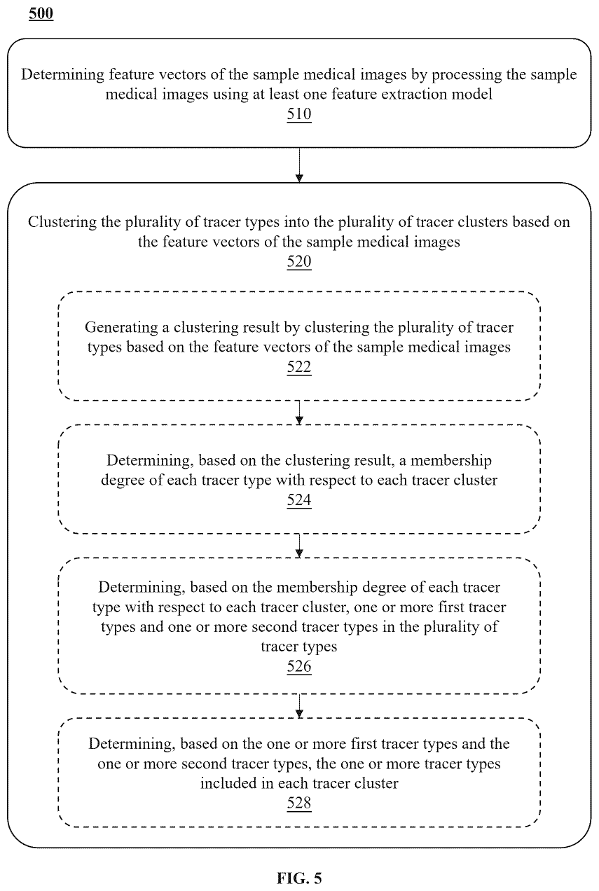

The processing device 120 may construct a feature vector for characterizing each sample medical image and cluster the tracer types based on the feature vector to obtain the tracer clusters. Detailed descriptions regarding the clustering of the tracer types may be found in FIG. 5 and its related descriptions.

In 430, for each tracer cluster, an image processing model corresponding to the tracer cluster is generated by training an initial image processing model using first sample medical images of the sample medical images. In some embodiments, operation 430 may be performed by the training module 230.

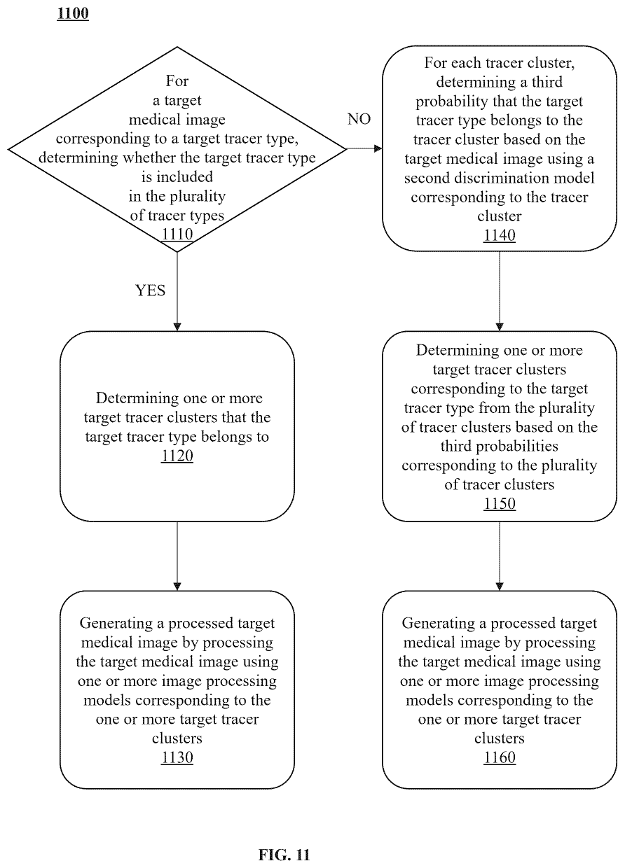

Each image processing model corresponds to one tracer cluster. For example, an image processing model 1, an image processing model 2, . . . , and an image processing model k may correspond to a tracer cluster 1, a tracer cluster 2, . . . , a tracer cluster k, respectively. The image processing model corresponding to a tracer cluster is used to process medical images corresponding to one or more tracer types in the tracer cluster. For example, the image processing model corresponding to the tracer cluster 1 may process medical images corresponding to tracer types such as FDG, PSMA, or the like, in the tracer cluster 1. The processing includes image recognition, image segmentation, image enhancement (e.g., noise reduction, artifact removal, etc.), image alignment, etc. Correspondingly, the image processing model includes an image recognition model, an image segmentation model, an image enhancement model, an image alignment model, or the like. For a tracer cluster, one or more image processing models may be generated. Detailed descriptions regarding processing the medical images using the image processing models may be found in FIG. 11 and its related descriptions.

In some embodiments, an image processing model may include one or more of a deep neural network (DNN) model, a convolutional neural network (CNN) model, a bidirectional encoder representation from transformers (BERT) model, or the like.

The first sample medical images refer to sample medical images corresponding to one or more tracer types in a single tracer cluster for training an image processing model corresponding to the tracer cluster. For example, continuing with the above example, the processing device 120 may determine the PET images corresponding to the tracers FDG and PSMA in the tracer cluster 1 as the first sample medical images, and these PET images are used to train the image processing model corresponding to the tracer cluster 1.

The image processing model corresponding to a tracer cluster may be further generated based on first training labels corresponding to the first sample medical images. Different image processing models correspond to different first training labels. For example, for an image noise reduction model, the first training label of a first sample medical image is a noise reduction image corresponding to the first sample medical image. As another example, for an image segmentation model, the first training label of a first sample medical image is a segmented image corresponding to the first sample medical image. The first training label may be manually calibrated or determined.

During the training process, the processing device 120 may input the first sample medical images into an initial image processing model, determine a value of a loss function based on an output of the initial image processing model and the first training labels, iteratively update the initial image processing model until an iteration condition is satisfied. Exemplary iteration conditions include that the value of the loss function is less than a threshold, that a difference of values of the loss function in two adjacent iterations is less than a threshold, that the number of iterations exceeds a threshold, or the like.

In some embodiments of the present disclosure, the tracer types are clustered to obtain the first sample medical images corresponding to each tracer cluster, thereby training the image processing model corresponding to each tracer cluster. The application scope of the image processing model corresponding to the tracer cluster is not limited to a single tracer type but to all of the tracer types in the tracer cluster. At the same time, there is no need to generate a corresponding image processing model for each tracer type, which reduces the number of the image processing models and the number of the training samples, improving the efficiency of training the image processing models.

In some embodiments, considering that new tracers may continue to emerge, the process 400 may further include operations 440-470 for determining whether the tracer clustering result generated above needs to be updated. Operations 440-470 may be performed by the updating module 260.

In 440, reference medical images corresponding to reference tracer types are obtained.

The reference tracer types refer to tracer types that are not included in the plurality of tracer types discussed in operation 410. A reference medical image refers to a medical image obtained by a scanning device after injecting a reference tracer into a sample subject.

In 450, for each reference tracer type, fourth probabilities that the reference tracer type belongs to the plurality of tracer clusters are determined based on the reference medical image(s) corresponding to the reference tracer type using second discrimination models corresponding to the plurality of tracer clusters.

The fourth probabilities of a reference tracer type refer to probabilities that the reference tracer type belongs to different tracer clusters. Determining the fourth probabilities using the second discrimination models is similar to determining the third probabilities using the second discrimination models as described in operation 1140 and descriptions thereof are not repeated herein.

In 460, for each reference tracer type, fourth position information of the reference tracer type in a feature space is determined based on the fourth probabilities.

The feature space refers to a space used to represent feature vectors corresponding to the tracer types. More descriptions regarding the feature space may be found in operation 520 of FIG. 5.

For example, based on the fourth probabilities corresponding to the tracer clusters, distance proportion information relating to a distance between the reference tracer type and the center of each tracer cluster in the feature space may be determined. Then, based on the distance proportion information, fourth position information of the reference tracer type in the feature space is determined. The greater the fourth probability corresponding to a tracer cluster, the shorter the distance between the reference tracer type and the center of the tracer cluster.

Merely by way of example, fourth probabilities corresponding to tracer cluster 1, tracer cluster 2, . . . tracer cluster k are 0.1, 0.2, . . . , 0.3, respectively, and the proportion between the distance from the reference tracer type to the center of tracer cluster 1, the center of the tracer cluster 2, . . . , and the center of the tracer cluster k in the feature space is 10:5: . . . : 3.3. Based on the proportion and the position information of the center of each tracer cluster, the fourth position information of the reference tracer type in the feature space may be determined.

In 470, whether the plurality of tracer clusters need to be updated is determined based on the fourth position information of each reference tracer type.

For example, the processing device 120 determines, based on the fourth position information for each reference tracer type, whether the reference tracer type may be clustered into an existing tracer cluster. When the reference tracer type is distant from the center of each tracer cluster (e.g., the distance to the center of each tracer cluster is greater than a distance threshold), it may be determined that the reference tracer type cannot be clustered into existing tracer clusters. The processing device 120 may further determine the number of reference tracer types that are unable to be clustered into the existing tracer clusters. If the number of reference tracer types exceeds a threshold, it is determined that the plurality of tracer clusters need to be updated. As another example, the processing device 120 determines, based on the fourth position information of each reference tracer type and the position information of the existing tracer cluster types in the feature space, whether the reference tracer type and the existing tracer types form a new cluster center. If a new cluster center is formed, the processing device 120 determines that the plurality of tracer clusters need to be updated.

When it is determined that the tracer clusters need to be updated, the processing device 120 may add the reference tracer type to the tracer types described in operation 410 and add the reference medical images to the sample medical images described in operation 410. The processing device 120 may re-execute operation 420 to determine new tracer clusters. Further, the processing device 120 may re-execute operation 430 to generate new image processing models.

In some embodiments, the processing device 120 may periodically perform operations 440-470. In some embodiments, when the number of reference tracer types exceeds a threshold (i.e., a specific number of new tracer types appears), the processing device 120 may perform operations 440-470.

In some embodiments of the present disclosure, the tracer clusters and the image processing models may be updated on time by analyzing new reference tracer types and reference medical images corresponding to the new reference tracer types. This approach enables the image processing models to be more accurate, thereby enhancing the reliability of medical image analysis and providing more accurate support for clinical diagnosis and research.

FIG. 5 is a flowchart illustrating a process of clustering a plurality of tracer types into a plurality of tracer clusters according to some embodiments of the present disclosure. In some embodiments, process 500 may be used to implement operation 420.

In 510, feature vectors of the sample medical images are determined by processing the sample medical images using at least one feature extraction model.

The feature vector of a sample medical image refers to a vector of features (e.g., depth features) used to describe the sample medical image.

A feature extraction model is a machine learning model for extracting image features. The feature extraction model includes a deep neural network (DNN) model, convolutional neural network (CNN) model, recurrent neural network model (RNN) model, etc. For each sample medical image, the processing device 120 may input the sample medical image into one of the at least one feature extraction model and obtain a feature vector output by the feature extraction model.

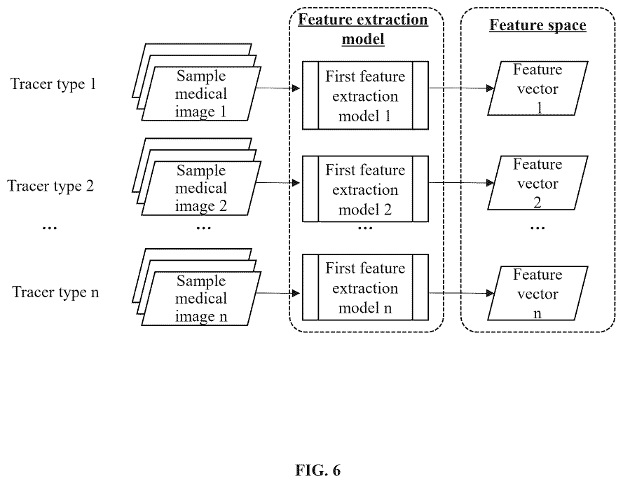

In some embodiments, the at least one feature extraction model includes a plurality of first feature extraction models. One first feature extraction model corresponds to one tracer type of the plurality of tracer types and is used for extracting a feature vector of a sample medical image corresponding to the tracer type. The feature vector for each sample medical image is determined by processing the sample medical image using a first feature extraction model corresponding to the same tracer type as that sample medical image. For example, as shown in FIG. 6, the at least one feature extraction model includes first feature extraction models 1-n (n is an integer greater than 1) corresponding to tracer types 1-n. The sample medical images 1-n corresponding to the tracer types 1-n are input into the first feature extraction models 1-n, respectively, to obtain the corresponding feature vectors 1-n.

In some embodiments, a supervised learning algorithm may be used to generate a first feature extraction model corresponding to each tracer type based on second sample medical images corresponding to each tracer type in the sample medical image. The second sample medical images are sample medical images corresponding to a single tracer type.

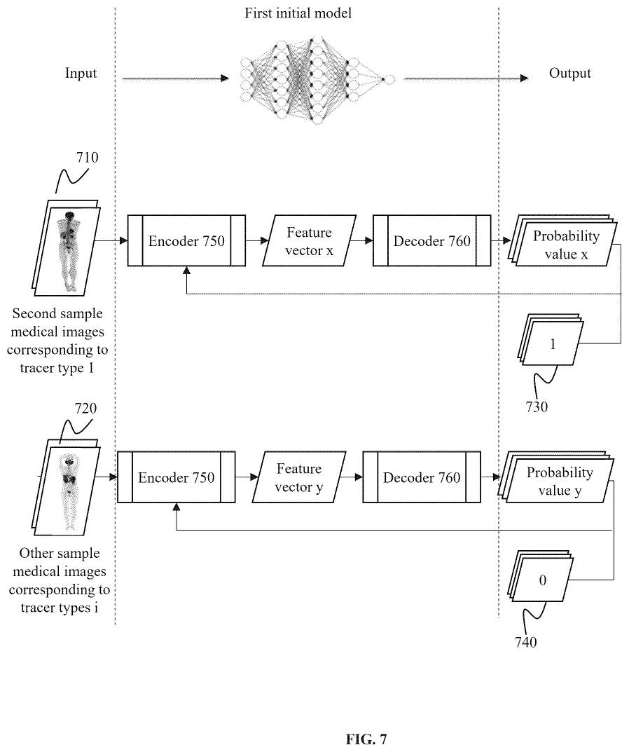

FIG. 7 is a schematic diagram illustrating a training process of a first feature extraction model according to some embodiments of the present disclosure. As shown in FIG. 7, a first initial model to be trained includes an encoder 750 and a decoder 760. The encoder in the present disclosure may include a CNN model, an RNN model, a Transformer model, or the like, and the decoder may include an RNN model, a Transformer model, or the like. Training samples of the first initial model include a first positive sample 710, a first negative sample 720, a second training label 730 corresponding to the first positive sample 710, and a second training label 740 corresponding to the first negative sample 720. The second training label 730 of the first positive sample 710 is 1, and the second training label 740 of the first negative sample 720 is 0. Taking tracer type 1 (e.g., FDG) as an example, second sample medical images (e.g., FDG sample medical images) corresponding to tracer type 1 are obtained from the sample medical images as the first positive sample. Other sample medical images (e.g., PSMA sample medical images, etc.) corresponding to other tracer types i (e.g., PSMA, etc.) (i is an integer other than 1) excluding tracer type 1 are obtained as the first negative sample. Exemplarily, the sample medical images may be images that can reflect the whole-body metabolic distribution level, such as chord diagrams and reconstructed diagrams generated based on original PET data. In this embodiment, no specific limitation is imposed on the image forms of the sample medical images.

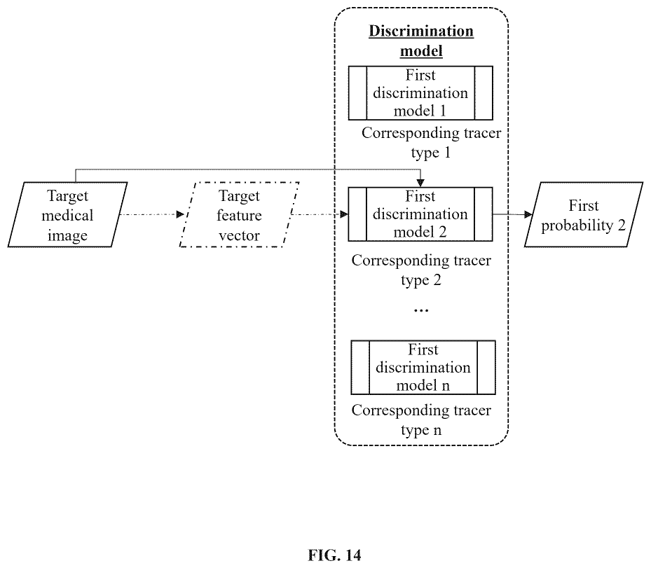

In the training process, the first positive sample 710 is input into the encoder 750, which performs feature extraction to obtain a feature vector x. The feature vector x is input into the decoder 760, which outputs a probability value x of the first positive sample 710 corresponding to the tracer type 1. Similarly, the encoder 750 obtains the feature vector y of the first negative sample 720, and the decoder 760 outputs the probability value y of the first negative sample 720 corresponding to the tracer type 1. Based on the probability value x and the second training label 1, and the probability value y and the second training label 0, a value of a loss function is determined. Parameters of the first initial model are gradually updated by backpropagation of the value of the loss function until the first initial model converges. After completing the training, the trained encoder 750 is designated as a first feature extraction model corresponding to tracer type 1, and the trained decoder 760 is designated as a first discrimination model corresponding to tracer type 1 (which will be described in detail in connection with FIG. 14). Using the same method described above, the first feature extraction models and first discrimination models corresponding to other tracer types may be obtained separately, which will not be repeated here.

It should be noted that in training the first feature extraction model corresponding to a tracer type, the first negative sample may be extracted from sample medical images other than the first positive sample by uniform sampling, considering the balance of the number of positive samples and negative samples. For example, when training the first feature extraction model corresponding to the tracer type 1, the sample medical images corresponding to the tracer type 1 may be designated as the first positive sample, and the first negative sample may be sampled uniformly from sample medical images corresponding to other tracer types. This sampling manner can not only satisfy the balance of the number of positive samples and negative samples, but also ensure the diversity and richness of the first negative sample and improve the network training effect.

In some embodiments of the present disclosure, a first feature extraction model corresponding to each tracer type may be obtained by supervised training, thereby enabling feature extraction to be carried out separately for each tracer type, which helps to improve the feature extraction accuracy. In addition, pixel-level representations of each PET tracer may be learned through the supervised training, which is more suitable for the situation where the tracer types in the existing PET data are comprehensive and the data volume is large.

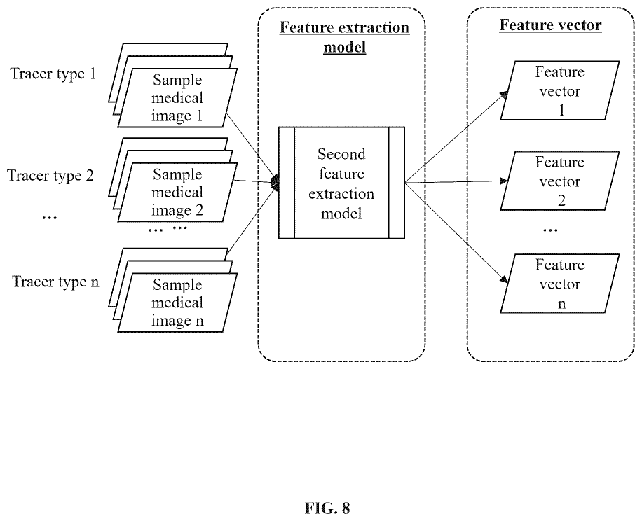

In some embodiments, the at least one feature extraction model includes one second feature extraction model corresponding to the plurality of tracer types. The second feature extraction model is used to extract the feature vectors of sample medical images corresponding to the plurality of tracer types. The feature vectors of the sample medical images are determined by processing each sample medical image using the second feature extraction model. For example, as illustrated in FIG. 8, the at least one feature extraction model includes one second feature extraction model corresponding to the tracer types 1-n. The sample medical images 1-n corresponding to the tracer types 1-n are input into the second feature extraction model, and feature vectors 1-n corresponding to the sample medical images 1-n may be obtained.

In some embodiments, the second feature extraction model may be generated based on the sample medical image corresponding to each tracer type using an unsupervised learning algorithm.

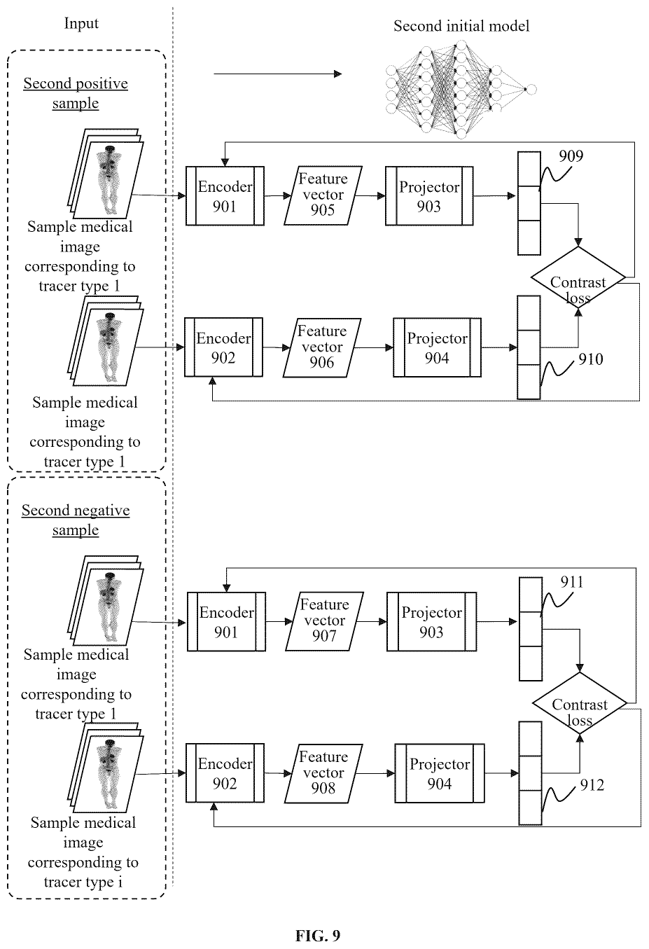

FIG. 9 is a schematic diagram illustrating a training process of a second feature extraction model according to some embodiments of the present disclosure. As shown in FIG. 9, the second initial model to be trained includes an encoder 901, an encoder 902, a projector 903, and a projector 904. Projectors in the present disclosure may include a fully connected layer, etc. The structures of the encoder 901 and the encoder 902 may be the same or different. The structures of the projector 903 and the projector 904 may be the same or different. Training samples of the second initial model may include a second positive sample and a second negative sample. The second positive sample includes a pair of sample medical images (e.g., FDG sample medical images) corresponding to the same tracer type (e.g., FDG). The second negative sample includes a pair of sample medical images (e.g., FDG sample medical image and PSMA sample medical) corresponding to different tracer types (e.g., FDG and PSMA). For example, referring to FIG. 9, the pair of sample medical images in the second positive sample both correspond to tracer type 1, and the pair of sample medical images in the second negative sample correspond to tracer types 1 and i, respectively.

During the training process, the two sample medical images in the second positive sample arc input into the encoder 901 and the encoder 902, respectively, and the encoder 901 and the encoder 902 output a feature vector 905 and a feature vector 906, respectively. The projector 903 and the projector 904 map the feature vector 905 and the feature vector 906 into two projection vectors 909 and 910, respectively. Two sample medical images in the second negative sample are input into the encoder 901 and the encoder 902, respectively, and the encoder 901 and the encoder 902 output a feature vector 907 and a feature vector 908, respectively. The projector 903 and the projector 904 map the feature vector 907 and the feature vector 908 into two projection vectors 911 and 912, respectively. Based on the projection vectors 909, 910, 911, and 912, a value of a contrast loss may be determined. Based on the value of the contrast loss, parameters of the second initial model are updated until the second initial model converges. After completing the training, the trained encoder 901 may be designated as the second feature extraction model.

In some embodiments of the present disclosure, unsupervised learning is used to train the second feature extraction model without labeling the training samples, which improves the training efficiency. In addition, the unsupervised learning algorithm requires only one feature extraction model to be trained, which reduces the amount of work involved in model training. Meanwhile, high-dimensional representations of each PET tracer may be learned through the unsupervised learning algorithm, thereby possessing strong generalization ability.

In 520, the plurality of tracer types are clustered into the plurality of tracer clusters based on the feature vectors of the sample medical images.

In some embodiments, the processing device 120 utilizes a clustering algorithm to cluster the tracer types into the plurality of tracer clusters based on the feature vectors of the sample medical images corresponding to each tracer type. There is a high similarity between the feature vectors corresponding to tracer types in the same tracer cluster while there is a large variability in the feature vectors corresponding to tracer types in different tracer clusters.

The clustering algorithm may include a soft clustering algorithm and a hard clustering algorithm. The soft clustering algorithm uses an affiliation function to represent the possibility or degree that each data point (i.e., a feature vector) belongs to each tracer cluster. The soft clustering algorithm may include a Fuzzy C-Means (FCM) algorithm, a Gaussian Mixture Model Soft Clustering (GMM Soft Clustering) algorithm, a neural network-based soft clustering algorithm, etc. The hard clustering algorithm directly divides each data point (i.e., a feature vector) into one tracer cluster with the closest distance from the data point. The hard clustering algorithms may include a K-Means algorithm, a K-Medoids algorithm, or the like.

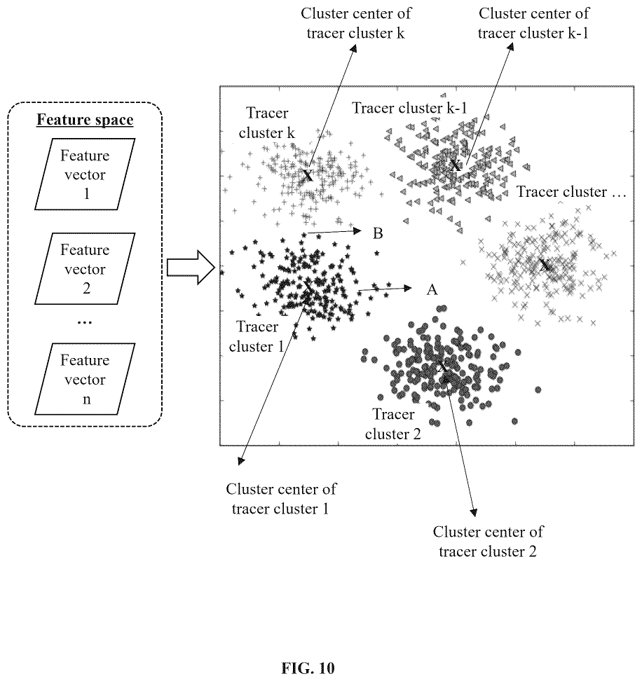

FIG. 10 is a schematic diagram illustrating a process of clustering tracer types according to some embodiments of the present disclosure. As shown in FIG. 10, n feature vectors corresponding to n sample medical images are clustered by the K-Means clustering algorithm to obtain k tracer clusters. Taking tracer cluster 1 as an example, a plurality of tracer types in the tracer cluster 1 may be regarded as tracers of the same type with high similarity, and any tracer type in the tracer cluster 1 and any tracer type in tracer cluster 2 may be regarded as different tracer types with a high variability. It should be noted that the number k of the tracer clusters should be less than the number n of tracers, i.e., k is less than n. In other words, at least one tracer cluster includes multiple tracers.

In some embodiments, a tracer type may correspond to multiple sample medical images, with each sample medical image having a corresponding feature vector, i.e., there may be multiple feature vectors corresponding to the tracer type. When clustering, the processing device may directly cluster with the tracer types based on the multiple feature vectors or perform certain operations on these feature vectors (e.g., after dimensionality reduction and averaging) and then cluster them.

In some embodiments, the clustering algorithm (e.g., the hard clustering algorithm) requires that each tracer type belong to only a single tracer cluster. In some embodiments, the clustering algorithm (e.g., the soft clustering algorithm) allows a tracer type to belong to multiple tracer clusters.

In some embodiments, step 520 may include steps 522 through 528.

In 522, a clustering result is generated by clustering the plurality of tracer types based on the feature vectors of the sample medical images.

The clustering result may be generated based on the clustering algorithm (e.g., fuzzy C-mean clustering algorithm, K-Means clustering algorithm).

In 524, based on the clustering result, a membership degree of each tracer type with respect to each tracer cluster is determined.

The membership degree of a tracer type with respect to a tracer cluster refers to the probability and/or degree that the tracer type belongs to the tracer cluster. The greater the membership degree, the greater the probability and/or the degree that the tracer type belongs to the tracer cluster.

When clustering is performed using the soft clustering algorithm, the membership degree of each tracer type with respect to each tracer cluster may be determined based on a membership function of the soft clustering algorithm. For example, in the case of the fuzzy C-mean clustering algorithm, the membership function may output a membership matrix U, where

Uij denotes the degree that the i^{th} tracer type belongs to the j^{th} tracer cluster. The membership degree satisfies Σⱼ₌₁^{k}Uᵢⱼ=1, where k denotes the number of tracer clusters.

When clustering is performed using the hard clustering algorithm, first position information of cluster centers of the plurality of tracer clusters in a feature space and second position information of the plurality of tracer types in the feature space may be determined based on the clustering result.

The cluster centers represent central positions or central features of the corresponding tracer cluster. The first position information includes the position of the cluster center of each tracer cluster in the feature space. Based on the clustering result, a mean vector of feature vectors of at least one tracer type within each tracer cluster is calculated. The mean vector is mapped to the feature space to determine a position of the cluster center of the tracer cluster in the feature space, thereby obtaining the first position information. For example, the position of the cluster center of each tracer cluster in FIG. 10 is represented by “X”.

The second position information includes a position of each tracer type in the feature space. Mapping the feature vector corresponding to each tracer type to the feature space allows determining the position of the tracer type in the feature space, thereby obtaining the second position information.

Further, based on the first position information and the second position information, the membership degree of each tracer type with respect to each tracer cluster is determined. Specifically, based on the first position information and the second position information, a distance between a position of each tracer type to a position of each cluster center is determined. For example, dᵢⱼ denotes the distance between the i^{th} tracer type and the cluster center of the j^{th} tracer cluster. Then, the inverse or negative exponential function of the distance is used to determine the membership degree of the tracer type belonging to the tracer cluster. For example, Uᵢⱼ=1/dᵢⱼ or Uᵢⱼ=epx(−βdᵢⱼ), where β denotes an adjusting parameter. Finally, the plurality of membership degrees of the i^{th} tracer type are normalized such that Σⱼ₌₁^{k}Uᵢⱼ=1.

In 526, based on the membership degree of each tracer type with respect to each tracer cluster, one or more first tracer types and one or more second tracer types in the plurality of tracer types are determined.

Each first tracer type belongs to one tracer cluster of the plurality of tracer clusters. Each second tracer type belongs to multiple tracer clusters of the plurality of tracer clusters.

For example, for each tracer type, a tracer cluster corresponding to a membership degree greater than a threshold is determined as the tracer cluster to which it belongs. If the number of tracer clusters to which it belongs is one, the tracer type is determined to be a first tracer type.

If there are multiple tracer clusters to which it belongs, the tracer type is determined to be a second tracer type. For example, as shown in FIG. 10, assuming the threshold is 0.3,membership degrees of the tracer type A belonging to tracer cluster 1, tracer cluster 2, . . . tracer cluster k−1, and tracer cluster k are 0.4, 0.1, . . . , 0.1, 0.1, 0.1, respectively, then tracer type A is the first tracer type belonging to tracer cluster 1. Membership degrees of the tracer type B belonging to tracer cluster 1, tracer cluster 2, . . . tracer cluster k-1, and tracer cluster k are 0.3, 0.1, . . . , 0.05, 0.4, respectively, then the tracer type B is the second tracer type belonging to tracer cluster 1 and tracer cluster k.

As another example, for each tracer type, the processing device 120 may analyze the distribution of the corresponding membership degrees. If the largest membership degree is much larger than the others (e.g., the difference exceeds a threshold), the tracer type is determined to be the first tracer type. If there are multiple membership degrees larger than the others and close in values, the tracer type is determined to be the second tracer type.

In 528, based on the one or more first tracer types and the one or more second tracer types, the one or more tracer types included in each tracer cluster are determined.

Based on the tracer clusters corresponding to the first tracer type and the second tracer type, the tracer types included in each tracer cluster may be determined. For example, continuing with the above example, the tracer cluster 1 includes at least the first tracer type A and the second tracer type B, and tracer cluster k at least includes the second tracer type B.

In some embodiments of the present disclosure, clustering of tracer clusters is achieved by determining one or more tracer clusters to which each tracer type belongs based on the membership degree of each tracer cluster. This clustering manner does not limit the number of tracer clusters to which each tracer cluster belongs, allowing a tracer type between two tracer clusters to be classified into two tracer clusters at the same time, increasing the flexibility of the clustering.

In some embodiments of the present disclosure, feature vectors of a plurality of sample medical images are obtained using at least one feature extraction model, and a plurality of tracer clusters are obtained by clustering different tracer types based on the feature vectors of the plurality of sample medical images, thereby improving the accuracy of categorizing different tracer types.

FIG. 11 is a flowchart illustrating a process of processing a target medical image according to some embodiments of the present disclosure. In some embodiments, process 1100 may be performed by the processing module 240.

In 1110, for a target medical image corresponding to a target tracer type, whether the target tracer type is included in the plurality of tracer types is determined.

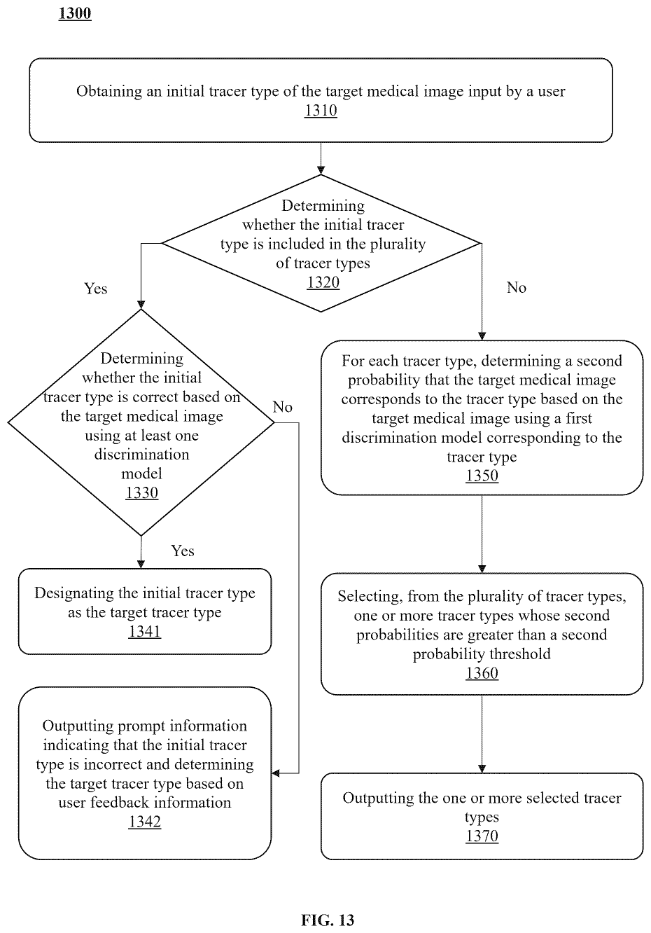

The target medical image refers to a medical image of a target subject to be processed. The target tracer type refers to the tracer type corresponding to the target medical image. In some embodiments, an initial tracer type of the target medical image input by the user may be verified to determine the target tracer type. Detailed descriptions regarding determining the target tracer type may be found in FIG. 13 and its related descriptions. In some embodiments, the initial tracer type entered by the user may be directly designated as the target tracer type.

The plurality of tracer types are the plurality of tracer types corresponding to the sample medical images used to train the image processing models. Detailed descriptions regarding the plurality of tracer types may be found in the related description of operation 410.

When it is determined that the target tracer type is included in the plurality of tracer types, the target tracer type is a known or processed tracer type, and operations 1120 to 1130 may be performed. When the target tracer type is not contained in the plurality of tracer types, the target tracer type is an unknown or unprocessed tracer type, and operations 1140 to 1160 may be performed.

In 1120, one or more target tracer clusters that the target tracer type belongs to are determined.

As described in operations 420 and 520, each tracer type is clustered into one or more tracer clusters during the clustering process. The one or more tracer clusters to which the target tracer type belongs may be referred to as the target tracer cluster(s). For example, the target tracer cluster to which the target tracer type A belongs is tracer cluster 1. As another example, the target tracer cluster to which the target tracer type B belongs is tracer cluster 1 and tracer cluster k

In 1130, a processed target medical image is generated by processing the target medical image using one or more image processing models corresponding to the one or more target tracer clusters.

When the target tracer type belongs to only one target tracer cluster (i.e., the one or more target tracer clusters include one target tracer cluster), the target medical image is processed using the image processing model corresponding to the target tracer cluster to generate the processed target medical image. For example, continuing with the above example, when the target tracer type is A, then the target medical image is processed using the image processing model 1 corresponding to the tracer cluster 1 to generate the processed target medical image.

When the target tracer type belongs to multiple target tracer clusters at the same time (i.e., the one or more target tracer clusters include multiple target tracer clusters), a processed target medical image may be generated based on the image processing models corresponding to the multiple target tracer clusters. For each target tracer cluster, the following operations may be performed. First, a membership degree of the target tracer type with respect to the target tracer cluster is determined. For example, it is determined that the target tracer type B has a membership degree of 0.3 with respect to tracer cluster 1 and a membership degree of 0.4 with respect to tracer cluster k. Detailed descriptions regarding the membership degree may be found in the related descriptions in operation 520. Then, a weight value corresponding to the target tracer cluster is determined based on the membership degree. The higher the membership degree, the higher the weight value corresponding to the membership degree. For example, for the target tracer type B, a weight value of 0.3/(0.3+0.4)=0.43 may be determined for tracer cluster 1 and a weight value of 0.4/(0.3+0.4)=0.57 may be determined for tracer cluster k. Further, a processing result (i.e., an intermediate processing result) is generated by processing the target medical image using the image processing model corresponding to the target tracer cluster.

After generating the processing result corresponding to each target tracer cluster, the processed target medical image may be generated based on the processing result and the weight value corresponding to each tracer cluster. For example, a processing result 1 and a processing result 2 are generated by processing the target medical image using the image processing model 1 corresponding to the tracer cluster 1 and the image processing model k corresponding to the tracer cluster k, respectively. Then, based on the weight values of 0.43 and 0.57, the processed target medical image is obtained by weighting and summing the processing result 1 and processing result 2.

Considering that the target tracer type may belong to multiple tracer clusters, some embodiments in the present disclosure rely on the membership degree and weight value to fuse processing results of multiple image processing models, thereby realizing the accurate processing of the target medical image. For example, the target tracer type “fibroblast activation protein (FAP)” is highly expressed in cancer-associated fibroblasts (CAFs) in most cancers, but is either lowly expressed or not expressed in normal tissues. On PET images, the target tracer FAP exhibits features that are partially similar to those of 18F-FDG and partially similar to those of 68Ga-FAPI-46. In this case, processing results obtained by using a plurality of image processing models corresponding to 18F-FDG and 68Ga-FAPI-46 are superior to processing results obtained by using a single image processing model. The integrin αvβ3 carried by the tracer 68Ga-FAPI-RGD is a transmembrane glycoprotein, which may be highly expressed in activated endothelial cells, newly formed blood vessels, and various types of tumor cells, but is lowly expressed or not expressed in normal cells. This manner improves the processing accuracy of medical images, especially medical images corresponding to complex tracers, and provides a more reliable basis for subsequent analysis of medical images, which significantly enhances the application value of the medical images in clinical diagnosis and research.

In some embodiments of the present disclosure, when the target tracer type is a known or processed tracer type, the image processing model(s) corresponding to the tracer cluster(s) to which the target tracer type belongs may be directly invoked to process the target medical image, and then the processed target medical image is obtained. This manner may directly invoke existing image processing model(s) to realize post-processing of the medical image and improve the image processing efficiency.

In 1140, for each tracer cluster, a third probability that the target tracer type belongs to the tracer cluster is determined based on the target medical image using a second discrimination model corresponding to the tracer cluster.

The third probability indicates the probability that the target medical image corresponding to the target tracer type belongs to a certain tracer cluster.

A second discrimination model corresponds to one tracer cluster. For example, the second discrimination model 1, the second discrimination model 2, . . . , and the second discrimination model k may correspond to the tracer cluster 1, the tracer cluster 2, . . . , tracer cluster k, respectively. The second discrimination model corresponding to one tracer cluster is used to determine whether a medical image corresponds to a tracer type in the tracer cluster, i.e., the second discrimination model is used to determine whether the medical image corresponds to a tracer type in the tracer cluster. More descriptions regarding the second discrimination model may be found in FIG. 13 to FIG. 16 and their related descriptions.

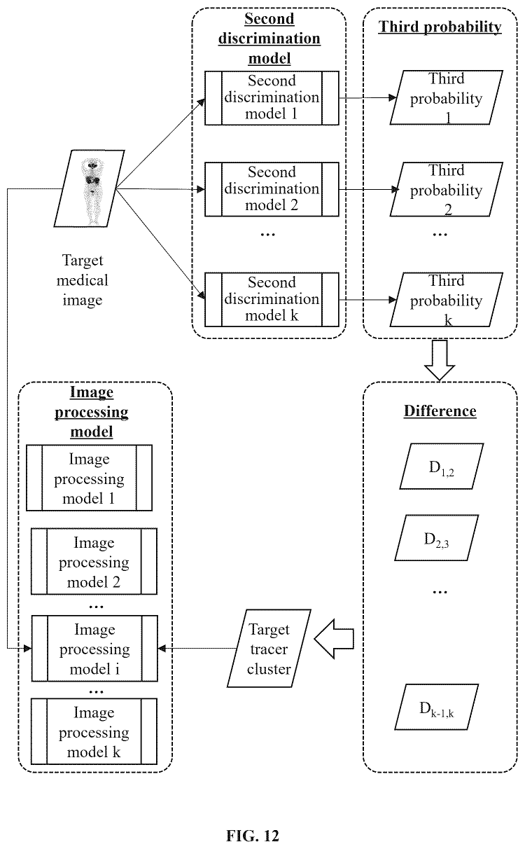

Specifically, the target medical image is input into a second discrimination model corresponding to each tracer cluster, and the second discrimination model outputs a corresponding third probability. If the third probability is high, the probability of the target medical image corresponding to a tracer type in the tracer cluster is high, i.e., the probability of the target tracer type belonging to the tracer cluster is high. As shown in FIG. 12, when the target tracer type is not included in the plurality of tracer types, the target medical image is input into the second discrimination model 1, the second discrimination model 2, . . . , and second discrimination model k, respectively, then the corresponding third probability 1, third probability 2, . . . , and third probability k may be obtained, respectively.

In 1150, one or more target tracer clusters corresponding to the target tracer type are determined from the plurality of tracer clusters based on the third probabilities corresponding to the plurality of tracer clusters.

In some embodiments, the processing device 120 may determine a tracer cluster corresponding to the largest third probability among third probabilities as the target tracer cluster. In some embodiments, the processing device 120 may determine one or more third probabilities that exceed a third probability threshold and determine one or more tracer clusters corresponding to those probabilities as the one or more target tracer clusters.

In some embodiments, the processing device 120 may determine one or more target tracer clusters based on differences between third probabilities corresponding to the plurality of tracer clusters. Specifically, the processing device 120 may determine a difference between any two third probabilities among k third probabilities corresponding to k tracer clusters. As shown in FIG. 12, D_{1.2}=|third probability 2-third probability 1|, D_{2.3}=|third probability 3-third probability 2|, . . . . Dₖ₋₁,k=| third probability k-third probability k−1|. The target tracer type is then determined to be a first tracer type or a second tracer type based on the differences. For example, when there is a tracer cluster that has the highest third probability and the differences between the third probability of the tracer cluster and the third probabilities of the other tracer clusters are all greater than or equal to a difference threshold, the target tracer type is determined to be the first tracer type. When multiple tracer clusters have higher third probabilities than the other tracers and the differences in probabilities of these tracer clusters are less than a difference threshold, the target tracer type is determined to be the second tracer type.

Further, in response to determining that the target tracer type is the first tracer type, a target tracer cluster is determined from the plurality of tracer clusters based on the third probabilities. For example, the tracer cluster with the largest third probability is selected as the target tracer cluster. In response to determining that the target tracer type is the second tracer type, multiple target tracer clusters are determined from the plurality of tracer clusters based on the third probabilities. For example, multiple tracer clusters with third probabilities that are close to each other and higher than the third probabilities of the other tracer clusters are determined as the target tracer clusters.

In 1160, a processed target medical image is generated by processing the target medical image using one or more image processing models corresponding to the one or more target tracer clusters.

When the target tracer type corresponds to only one target tracer cluster (i.e., the one or more target tracer clusters include one target tracer cluster), the target medical image may be processed using an image processing model corresponding to the target tracer cluster to generate the processed target medical image. Detailed descriptions regarding processing the target medical image using the image processing model corresponding to the target tracer cluster may be found in the related descriptions in operation 1130, and will not be repeated here.

When the target tracer type corresponds to multiple target tracer clusters (i.e., the one or more target tracer clusters include multiple target tracer clusters), for each target tracer cluster, the following operations are performed. First, based on the third probability corresponding to the target tracer cluster, the weight value corresponding to the target tracer cluster is determined. The greater the third probability, the higher the weight value corresponding to the third probability. For example, the target tracer clusters include tracer cluster 2 and tracer cluster k, which correspond to third probabilities of 0.8 and 0.7, respectively. A weight value of 0.8/(0.8+0.7)=0.53 may be determined for tracer cluster 2, and a weight value of 0.7/(0.8+0.7)=0.47 may be determined for tracer cluster k. A processing result (i.e., an intermediate processed target medical image) is then generated by processing the target medical image using the image processing model corresponding to the target tracer cluster.

After obtaining the processing result corresponding to each target tracer cluster, the processed target medical image is generated based on the processing result and weight value corresponding to each target tracer cluster. Detailed descriptions regarding generating the processed target medical image may be found in the related descriptions in operation 1130 and will not be repeated herein.

In some embodiments, for an unknown or unprocessed tracer type, a target medical image corresponding to the tracer type may be input into a second discrimination model corresponding to each the tracer cluster for discriminating the tracer type, so that a third probability output by the second discrimination model may be obtained. Then, one or more target tracer clusters matching the tracer type may be determined based on the third probability, so that the target medical image may be processed using the image processing model(s) corresponding to the target tracer cluster(s). In this way, medical images corresponding to a brand-new tracer type may be quickly processed using existing image processing models, thereby meeting the ever-changing needs of image processing and reducing the workload of model training.

FIG. 13 is a flowchart illustrating a process of determining a target tracer type of a target medical image according to some embodiments of the present disclosure. In some embodiments, process 1300 is used to determine the target tracer type of the target medical image described in operation 1110.

In some cases, information about the tracer, including the initial tracer type, and other parameters related to the image reconstruction, etc., are typically entered manually by a doctor before performing the scan. Due to the manual entry, the tracer type may be inevitably entered incorrectly, e.g., tracer type A is actually injected, while the doctor enters tracer type B (i.e., the initial tracer type). In this case, after the target medical image is obtained by the reconstruction, the processing device 120 invokes an image processing model corresponding to tracer type B to process the target medical image. Because the actual target medical image is a medical image corresponding to the tracer type A, adopting the image processing model corresponding to the tracer type B may result in a poor image processing effect or even a failure to obtain the processing result. To address this problem, a manner for validating the tracer type entered by the doctor (i.e., the initial tracer type) is provided in FIG. 13.

In 1310, an initial tracer type of the target medical image input by a user is obtained.

The initial tracer type refers to a tracer type corresponding to the target medical image entered by the user.

In 1320, whether the initial tracer type is included in the plurality of tracer types is determined. In response to determining that the initial tracer type is included in the plurality of tracer types, operations 1330 and 1341 or operations 1330 and 1342 may be performed. In response to determining that the initial tracer type is not included in the plurality of tracer types, the process 1300 may be ended, or operations 1350 to 1370 may be performed.

In 1330, whether the initial tracer type is correct is determined based on the target medical image using at least one discrimination model.

A discrimination model is a trained machine learning model for determining the tracer type corresponding to a medical image. The discrimination model may include one or a combination of one or more of the support vector machine model, logistic regression model, deep neural network (DNN) model, convolutional neural network (CNN) model, or the like.

In some embodiments, the at least one discrimination model includes a plurality of first discrimination models. Each first discrimination model corresponds to one tracer type among the plurality of tracer types. A first discrimination model corresponding to a tracer type may be used to discriminate whether a medical image corresponds to the tracer type or a probability that the medical image corresponds to the tracer type.

Specifically, a first probability that the target medical image corresponds to the initial tracer type is determined based on the target medical image using the first discrimination model corresponding to the initial tracer type. The first probability is the probability that the target medical image corresponds to the initial tracer type. For example, as illustrated in FIG. 14, the at least one discrimination model includes first discrimination models 1-n corresponding to tracer types 1-n, respectively. Assuming that the initial tracer type is tracer type 2, the target medical image or a target feature vector corresponding to the target medical image is input into the first discrimination model 2 corresponding to the tracer type 2, and the first discrimination model outputs the corresponding first probability 2.

In some embodiments, the first probability may be determined by inputting the target feature vector of the target medical image into the first discrimination model corresponding to the initial tracer type. The target feature vector refers to a vector for characterizing the features of the target medical image, which may be determined by the first feature extraction model corresponding to the initial tracer type. In this case, the first feature extraction model and the first discrimination model corresponding to each tracer type are trained jointly using a supervised learning algorithm based on second sample medical images corresponding to each tracer type. For example, as described in FIG. 7, the first feature extraction model is the trained encoder 750, and the first discrimination model is the trained decoder 760. Detailed descriptions regarding the co-training process may be found in FIG. 7 and its related descriptions.

In some embodiments, the first probability may be determined by inputting the target medical image into the first discrimination model corresponding to the initial tracer type. In such cases, the first feature extraction model and the first discrimination model corresponding to each tracer type are trained separately using the supervised learning algorithm based on second sample medical images corresponding to each tracer type. Taking tracer type 2 as an example, the first feature extraction model of the tracer type 2 is trained using the supervised learning algorithm described in FIG. 7, and the first discrimination model of the tracer type 2 may be trained separately. Training samples of the first discrimination model include second sample medical images corresponding to the tracer type 2 and its training label 1, and sample images corresponding to other tracer types and its training label 0.

In some embodiments, the at least one discrimination model includes a plurality of second discrimination models. Each second discrimination model corresponds to one tracer cluster of the plurality of tracer clusters. The second discrimination model corresponding to one tracer cluster may be used to discriminate whether a medical image corresponds to a tracer type in the tracer cluster or the probability that the medical image corresponds to a tracer type in the tracer cluster.

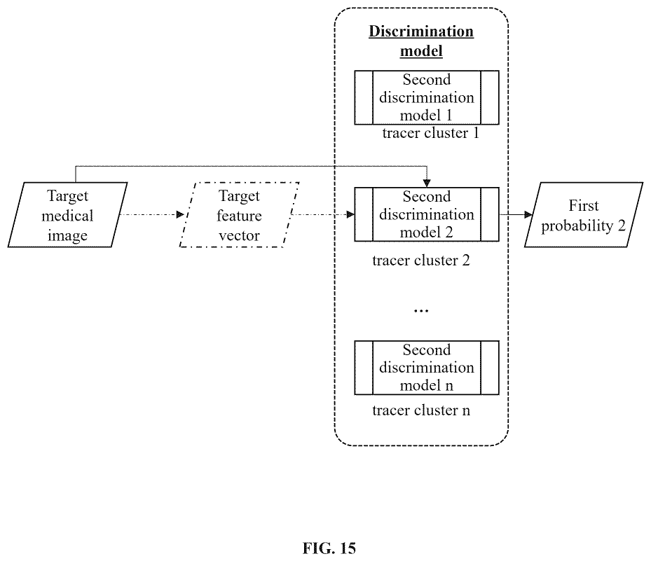

Specifically, one or more tracer clusters to which the initial tracer type belongs may be determined, and one or more second discrimination models corresponding to the one or more tracer clusters may be used to determine the first probability based on the target medical image. As shown in FIG. 15, the at least one discrimination model includes second discrimination models 1-k. Assuming that the initial tracer type is tracer type 2 belongs to tracer cluster 2, the processing device 120 may determine a first probability 2 by directly inputting the target medical image or the target feature vector of the target medical image into the second discrimination model 2 corresponding to the tracer cluster 2. The probability value output by the second discrimination model 2 represents the probability that the target medical image corresponds to a tracer type in the tracer cluster 2, which may be designated as the first probability that the target medical image corresponds to the initial tracer type (i.e., tracer type 2). If the initial tracer type corresponds to multiple tracer clusters, probability values output by multiple second discrimination models corresponding to those tracer clusters may be averaged to determine the first probability.

In some embodiments, a second discrimination model may be obtained by using the supervised learning algorithm.

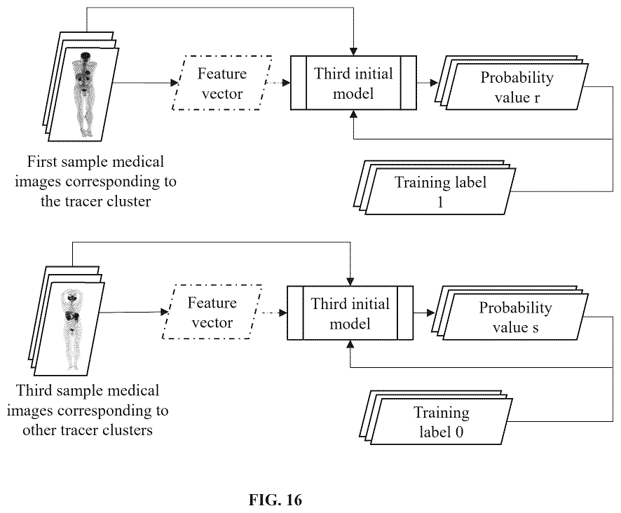

As shown in FIG. 16, for a given tracer cluster, first sample medical images corresponding to one or more tracer types in the tracer cluster and third sample medical images corresponding to tracer types other than the tracer cluster may be determined. Further, as indicated by the solid arrows in FIG. 16, the first sample medical images and the third sample medical images may be used as training inputs, tracer cluster labels of the first sample medical images and the third sample medical images may be used as training labels, and the third initial model is trained to obtain the second discriminant model corresponding to the tracer cluster. The training labels of the first sample medical images are 1, and the training labels of the third sample medical images are 0. Alternatively, as indicated by the dashed arrows in FIG. 16, feature vectors of the first sample medical images and the third sample medical images may be used as training inputs. The feature vectors are determined using the second feature extraction model corresponding to the tracer clusters.

In the training process, the first sample medical images (or their feature vectors) and the third sample medical images (or their feature vectors) are input into the third initial model, respectively, and the third initial model outputs the corresponding probability value r and the probability value s, respectively. Based on the probability value r and the training label 1, and the probability value s and the training label 0, the value of the loss function is determined. Parameters of the third initial model are gradually updated through back propagation of the value of the loss function until the model converges, and a trained second discrimination model corresponding to the tracer cluster is obtained.

In some embodiments of the present disclosure, training the second discrimination model for each tracer cluster, rather than a specific tracer type, may reduce the model training workload.

After determining the first probability based on the first discrimination model or the second discrimination model, it may be possible to determine whether the initial tracer type is correct based on the first probability and the first probability threshold. For example, when the first probability is greater than the first probability threshold, it may be considered that the initial tracer type entered by the user is correct; otherwise, there is a relatively high likelihood that the tracer information input is incorrect.

It should be noted that when the second discrimination model is used, the initial tracer type being correct means that the target medical image matches the tracer cluster to which the initial tracer type belongs, and it does not mean that the initial tracer type entered is identical to the actual tracer type injected. However, since the target medical image matches the tracer cluster, the image processing model corresponding to the tracer cluster also matches the target medical image, which ensures the accuracy of image processing. When it is determined that the target medical image matches the tracer cluster to which the initial tracer type belongs, it may be determined that the input initial tracer type is correct. Because even if the input initial tracer type does not match the actual tracer type, it is at least assured that the input initial tracer type is characteristically similar to the actual tracer type and belongs to the same tracer cluster, and user input errors may not adversely affect image post-processing.

In 1341, in response to determining that the initial tracer type is correct, the initial tracer type is designated as the target tracer type.

In 1342, in response to determining that the initial tracer type is incorrect, prompt information indicating that the initial tracer type is incorrect is output and the target tracer type is determined based on user feedback information. The prompt information is used to indicate that the initial tracer type is incorrect. The user may enter the user feedback based on the prompt information. The user feedback information is the initial tracer type that the user re-enters. When the user feedback information is obtained, operations 1310 to 1340 may be repeated to determine the target tracer type. Alternatively, the user feedback information indicates that the initial tracer type is accurate and does not need to be modified, and the initial tracer type may be designated as the target tracer type.

In some embodiments of the present disclosure, it is possible to verify the initial tracer type manually input by the user, thereby improving the reliability and accuracy of the input tracer information, and avoiding the problem of poor image processing effect during image post-processing due to the user input error.

In 1350, for each tracer type, a second probability that the target medical image corresponds to the tracer type is determined based on the target medical image using a first discrimination model corresponding to the tracer type.

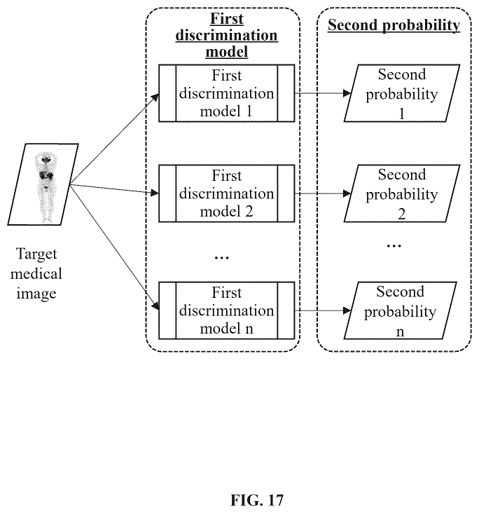

The second probability corresponding to a tracer type is the probability that the target medical image corresponds to the tracer type. For example, as shown in FIG. 17, by inputting the target medical image into the first discrimination models 1-n, respectively, the corresponding second probabilities 1-n may be respectively obtained. As another example, by inputting the target feature vector of the target medical image into the first discrimination models 1-n, respectively, the corresponding second probabilities 1-n may be obtained, respectively. More descriptions regarding the first discrimination models may be found in FIG. 14.

In 1360, one or more tracer types whose second probabilities are greater than a second probability threshold are selected from the plurality of tracer types.

In 1370, one or more selected tracer types are output.

In some embodiments, when the initial tracer type entered by the user is not a known or processed tracer type, a tracer type that matches better to the target medical image (i.e., a tracer type with a second probability greater than the second probability threshold) may be determined based on the first discrimination model corresponding to each tracer type. Then, the matching tracer type is output to the user to assist the user in judging and modifying the initial tracer type based on the matching tracer type, thereby improving the accuracy of the tracer information. Exemplarily, a tracer candidate list may be generated based on one or more tracer categories and output to the user, so as to prompt the user to confirm the recorded tracer information based on the tracer candidate list.

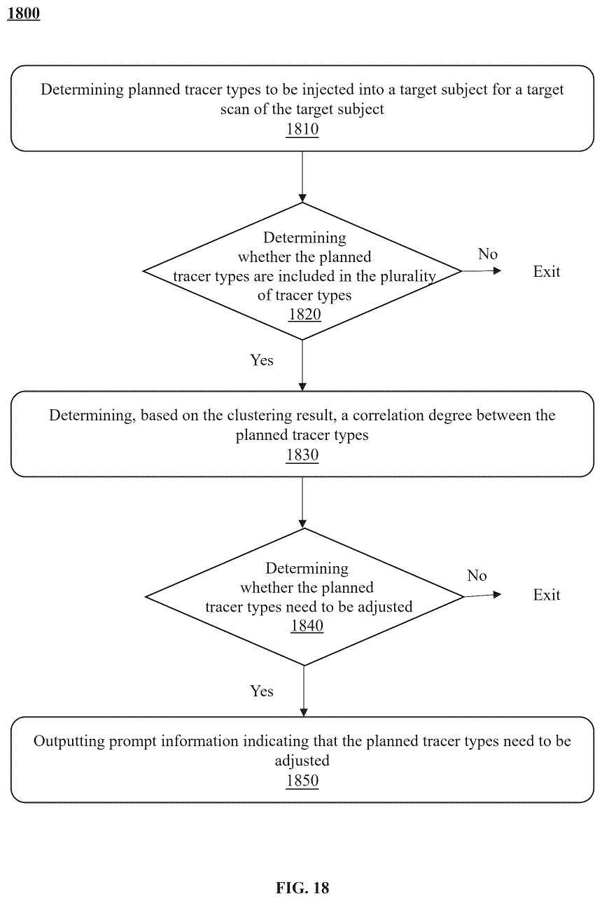

FIG. 18 is a flowchart illustrating a process of determining whether planned tracer types need to be adjusted according to some embodiments of the present disclosure. In some embodiments, process 1800 may be performed by the adjustment module 250. In some embodiments, process 1800 may be performed after operation 420.

In 1810, planned tracer types to be injected into a target subject for a target scan of the target subject are determined.

The target scan refers to a scan planned to be performed on the target subject. The planned tracer types refer to tracer types that are planned to be injected into the target subject before or during the target scan. In some cases, in order to understand the condition of the target subject from various perspectives, it is necessary to inject multiple tracer types so that medical images corresponding to the multiple tracer types are respectively obtained by reconstruction after the target scan. However, when the multiple tracer types are related (e.g., similar), it is difficult to split image data corresponding to the multiple tracer types during image reconstruction, resulting in poor image reconstruction. As such, whether the planned tracer types need to be adjusted due to a high correlation may be further determined based on operations 1820-1840.

In some embodiments, the planned tracer types to be injected into the target subject may be determined based on a scan protocol corresponding to the target scan.

In 1820, whether the planned tracer types are included in the plurality of tracer types is determined. In response to determining that the planned tracer types are included in the plurality of tracer types, operations 1830 to 1850 are performed. In response to determining that the planned tracer types are not included in the plurality of tracer types, the current process is exited.

In 1830, a correlation degree between the planned tracer types is determined based on the clustering result.

Detailed descriptions regarding the clustering result may be found in the related description in operation 522.

The correlation degree may reflect the degree of correlation or similarity between the planned tracer types. The higher the correlation degree, the greater the similarity between the planned tracer types, and the more difficult it is to distinguish the scan data corresponding to each planned tracer type in image reconstructing.

Merely by way of example, for each planned tracer type, the processing device 120 may determine a membership degree vector of the planned tracer type to each tracer cluster based on the membership degree of the planned tracer type with respect to each tracer cluster. The membership degree of the planned tracer type with respect to each tracer cluster is similar to the membership degree of the tracer type with respect to each tracer cluster in operation 524 and is not repeated here. The membership degree vector refers to a vector for representing the membership degree between the planned tracer type and each tracer cluster. For example, if the membership degrees of the planned tracer type 1 with respect to the tracer clusters 1-k are B1,B2, . . . . Bk, the membership degree vector of the planned tracer type 1 is [B1, B2, . . . , Bk]. The processing device 120 may then determine the correlation degree based on the membership degree vector corresponding to each planned tracer type. For example, the correlation degree may include one or more correlation degrees between one or more pairs of planned tracer types. The correlation degree between a pair of planned tracer types may be equal to the inverse of a distance between the membership degree vectors of the pair of planned tracer types. The distance may include a Euclidean distance, a Manhattan distance, a cosine distance, etc. As another example, if there are multiple pairs of planned tracer types, their corresponding correlation degrees may be averaged to determine the final correlation degree.

As yet another example, the processing device 120 may obtain a corresponding position of each planned tracer type in the feature space of the clustering result and determine a correlation degree between each pair of planned tracer types based on the distance between corresponding positions of the pair of planned tracer types. The closer the distance between the positions, the higher the corresponding correlation degree.

In 1840, whether the planned tracer types need to be adjusted is determined based on the correlation degree. In response to determining that the planned tracer types need to be adjusted, operation 1850 may be performed. In response to determining that the planned tracer types do not need to be adjusted, the current process is exited.

For example, when the correlation degree between any pair of planned tracer types exceeds a correlation threshold, it is determined that the planned tracer types need to be adjusted.

In 1850, prompt information indicating that the planned tracer types need to be adjusted is output.

In some embodiments of the present disclosure, analyzing the correlation degree between the planned tracer types before scanning to determine whether to adjust the planned tracer types may prevent situations in which it is difficult to differentiate scan data corresponding to the planned tracer types, thereby improving scanning accuracy and efficiency.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for generating image processing models, implemented on a computing device having at least one processor and at least one storage device, the method comprising:
obtaining sample medical images corresponding to a plurality of tracer types;
determining a plurality of tracer clusters based on the sample medical images, each tracer cluster including one or more tracer types of the plurality of tracer types; and
for each tracer cluster, generating an image processing model corresponding to the tracer cluster by training an initial image processing model using first sample medical images of the sample medical images, the first sample medical images corresponding to the one or more tracer types in the tracer cluster.

2. The method of claim 1, wherein the determining a plurality of tracer clusters based on the sample medical images comprises:
determining feature vectors of the sample medical images by processing the sample medical images using at least one feature extraction model, the at least one feature extraction model being at least one trained machine learning model; and
clustering the plurality of tracer types into the plurality of tracer clusters based on the feature vectors of the sample medical images.

3. The method of claim 2, wherein the at least one feature extraction model includes a plurality of first feature extraction models each of which corresponds to one of the plurality of tracer types,
the first feature extraction model corresponding to one tracer type is generated based on second sample medical images of the sample medical images using a supervised learning algorithm, the second sample medical images corresponding to the tracer type, and
for each sample medical image, the feature vector of the sample medical image is determined by processing the sample medical image using the first feature extraction model corresponding to the same tracer type as the sample medical image.

4. The method of claim 2, wherein the at least one feature extraction model includes one second feature extraction model corresponding to the plurality of tracer types,
the second feature extraction model is generated based on the sample medical images using an unsupervised learning algorithm,
the feature vectors of the sample medical images are determined by processing each sample medical image using the second feature extraction model.

5. The method of claim 2, wherein the determining the plurality of tracer clusters based on the feature vectors of the sample medical images comprises:
generating a clustering result by clustering the plurality of tracer types based on the feature vectors of the sample medical images;
determining, based on the clustering result, a membership degree of each tracer type with respect to each tracer cluster;
determining, based on the membership degree of each tracer type with respect to each tracer cluster, one or more first tracer types and one or more second tracer types in the plurality of tracer types, each first tracer type belonging to one tracer cluster among the plurality of tracer clusters, each second tracer type belonging to multiple tracer clusters among the plurality of tracer clusters; and
determining, based on the one or more first tracer types and the one or more second tracer types, the one or more tracer types included in each tracer cluster.

6. The method of claim 5, wherein the method further comprises:
determining planned tracer types to be injected into a target subject for a target scan of the target subject;
in response to determining that the planned tracer types are included in the plurality of tracer types, determining, based on the clustering result, a correlation degree between the planned tracer types;
determining whether the planned tracer types need to be adjusted based on the correlation degree;
in response to determining that the planned tracer types need to be adjusted, output prompt information indicating that the planned tracer types need to be adjusted.

7. The method of claim 1, wherein the method further comprises:
for a target medical image corresponding to a target tracer type, determining whether the target tracer type is included in the plurality of tracer types;
in response to determining that the target tracer type is included in the plurality of tracer types, determining one or more target tracer clusters that the target tracer type belongs to; and
generating a processed target medical image by processing the target medical image using one or more image processing models corresponding to the one or more target tracer clusters.

8. The method of claim 7, wherein the one or more target tracer clusters include multiple target tracer clusters, and the processed target medical image is generated by:
for each target tracer cluster,
determining a membership degree of the target tracer type with respect to the target tracer cluster;
determining a weight value corresponding to the target tracer cluster based on the membership degree; and
generating a processing result by processing the target medical image using the image processing model corresponding to the target tracer cluster; and
generating the processed target medical image based on the processing result and the weight value corresponding to each target tracer cluster.

9. The method of claim 7, wherein the target tracer type of the target medical image is determined by:
obtaining an initial tracer type of the target medical image input by a user;
in response to determining that the initial tracer type is included in the plurality of tracer types,
determining whether the initial tracer type is correct based on the target medical image using at least one discrimination model, the at least one discrimination model being at least one trained machine learning model;
in response to determining that the initial tracer type is correct, designating the initial tracer type as the target tracer type; or in response to determining that the initial tracer type is incorrect, outputting prompt information indicating that the initial tracer type is incorrect and determining the target tracer type based on user feedback information.

10. The method of claim 9, wherein the at least one discrimination model includes a plurality of first discrimination models each of which corresponds to one of the plurality of tracer types, the determining whether the initial tracer type is correct comprises:
determining a first probability that the target medical image corresponds to the initial tracer type based on the target medical image using the first discrimination model corresponding to the initial tracer type; and
determining whether the initial tracer type is correct based on the first probability and a first probability threshold.

11. The method of claim 9, wherein the at least one discrimination model includes a plurality of second discrimination models each of which corresponds to one of the plurality of tracer clusters, the determining whether the initial tracer type is correct comprises:
determining one or more tracer clusters that the initial tracer type belongs to;
determining a first probability that the target medical image corresponds to the initial tracer type based on the target medical image using the one or more second discrimination models corresponding to the one or more tracer clusters;
determining whether the initial tracer type is correct based on the first probability and a first probability threshold.

12. The method of claim 7, wherein the target tracer type of the target medical image is determined by:
obtaining an initial tracer type of the target medical image input by a user;
in response to determining that the initial tracer type is not included in the plurality of tracer types,
for each tracer type, determining a second probability that the target medical image corresponds to the tracer type based on the target medical image using a first discrimination model corresponding to the tracer type;
selecting, from the plurality of tracer types, one or more tracer types whose second probabilities are greater than a second probability threshold; and
outputting the one or more selected tracer types.

13. The method of claim 1, wherein the method further comprises:
for a target medical image corresponding to a target tracer type, determining whether the target tracer type is included in the plurality of tracer types;
in response to determining that the target tracer type is not included in the plurality of tracer types,
for each tracer cluster, determining a third probability that the target tracer type belongs to the tracer cluster based on the target medical image using a second discrimination model corresponding to the tracer cluster;
determining one or more target tracer clusters corresponding to the target tracer type from the plurality of tracer clusters based on the third probabilities corresponding to the plurality of tracer clusters; and
generating a processed target medical image by processing the target medical image using one or more image processing models corresponding to the one or more target tracer clusters.

14. The method of claim 13, wherein the one or more target tracer clusters include multiple target tracer clusters, and the processed target medical image is generated by:
for each target tracer cluster,
determining a weight value corresponding to the target tracer cluster based on the third probability corresponding to the target tracer cluster; and
generating a processing result by processing the target medical image using the image processing model corresponding to the target tracer cluster; and
generating the processed target medical image based on the processing result and the weight value corresponding to each target tracer cluster.

15. The method of claim 1, wherein the method further comprises:
obtaining reference medical images corresponding to reference tracer types that are not included in the plurality of tracer types;
for each reference tracer type,
determining, based on the reference medical image corresponding to the reference tracer type, fourth probabilities that the reference tracer type belongs to the plurality of tracer clusters using second discrimination models corresponding to the plurality of tracer clusters;
determining fourth position information of the reference tracer type in a feature space based on the fourth probabilities; and
determining whether the plurality of tracer clusters need to be updated based on the fourth position information of each reference tracer type.

16. A system, comprising:
at least one storage medium storing a set of instructions; and
at least one processor configured to communicate with the at least one storage medium, wherein when executing the set of instructions, the at least one processor is directed to cause the system to perform operations including:
obtaining sample medical images corresponding to a plurality of tracer types;
determining a plurality of tracer clusters based on the sample medical images, each tracer cluster including one or more tracer types of the plurality of tracer types; and
for each tracer cluster, generating an image processing model corresponding to the tracer cluster by training an initial image processing model using first sample medical images of the sample medical images, the first sample medical images corresponding to the one or more tracer types in the tracer cluster.

17. The system of claim 16, wherein the at least one feature extraction model includes one second feature extraction model corresponding to the plurality of tracer types,
the second feature extraction model is generated based on the sample medical images using an unsupervised learning algorithm,
the feature vectors of the sample medical images are determined by processing each sample medical image using the second feature extraction model.

18. The system of claim 16, wherein the determining a plurality of tracer clusters based on the sample medical images comprises:
determining feature vectors of the sample medical images by processing the sample medical images using at least one feature extraction model, the at least one feature extraction model being at least one trained machine learning model; and
clustering the plurality of tracer types into the plurality of tracer clusters based on the feature vectors of the sample medical images.

19. The system of claim 18, wherein the determining the plurality of tracer clusters based on the feature vectors of the sample medical images comprises:
generating a clustering result by clustering the plurality of tracer types based on the feature vectors of the sample medical images;
determining, based on the clustering result, a membership degree of each tracer type with respect to each tracer cluster;
determining, based on the membership degree of each tracer type with respect to each tracer cluster, one or more first tracer types and one or more second tracer types in the plurality of tracer types, each first tracer type belonging to one tracer cluster among the plurality of tracer clusters, each second tracer type belonging to multiple tracer clusters among the plurality of tracer clusters; and
determining, based on the one or more first tracer types and the one or more second tracer types, the one or more tracer types included in each tracer cluster.

20. A non-transitory computer readable medium, comprising at least one set of instructions, wherein when executed by at least one processor of a computer device, the at least one set of instructions directs the at least one processor to perform operations including:
obtaining sample medical images corresponding to a plurality of tracer types;
determining a plurality of tracer clusters based on the sample medical images, each tracer cluster including one or more tracer types of the plurality of tracer types; and
for each tracer cluster, generating an image processing model corresponding to the tracer cluster by training an initial image processing model using first sample medical images of the sample medical images, the first sample medical images corresponding to the one or more tracer types in the tracer cluster.
